(19) United States
(12) Patent Application Publication
(10) Pub. No.: US 2005/0279575 A1
(43) Pub. Date: Dec. 22, 2005

(54) Pro ladder set

(75) Inventors: Robert Vincent Fougere, Dartmouth (CA); Peter James Archibald, Truro (CA); Myles J. Fougere, Halifax (CA)

Correspondence Address: Pro Ladder Set Limited;C/o Holly Leahy, 57 Country Club Lane, Falmouth, NS, B0P 1L0, CA

(73) Assignee: Pro Ladder Set Limited

(21) Appl. No.: 10/868,882

(22) Filed: Jun. 17, 2004

(51) Int. Cl. E06C 7/42

(52) U.S. Cl. 182/18

(57) ABSTRACT

The invention generally relates to ladders and indicators and specifically to safe inclination indicators for ladders. This invention is designed to indicate the optimal inclination of a ladder for stability and is read from both the front and side of the ladder, using a pendulum control arm that lines up with preset index markings at 75½ degrees from the horizontal. Another object of our invention is to provide a self-clamping device with a built-in safety release mechanism. A further object of our invention is that it can be used on ladders of any length and it does not affect the strength of the ladder.

### BACKGROUND OF THE INVENTION

According to conventional safety regulations, the traditional method of determining the safest working position of a non-self-supporting ladder is to position the ladder against the supporting surface such that the distance between the wall and the base of a ladder is one-quarter (¼) the working length of the ladder. The working length is defined as the distance along the ladder between the foot and the top support. Additionally, the optimal angle for a ladder to sustain loads vertically downward is 75½ degrees from the horizontal. If the angle is less than 75½ degrees it lowers the capacity of the ladder; if it is greater than 75½ degrees the ladder is difficult to climb and increases the tendency for the ladder to fall backward.

The first indicator element shown in the U.S. Pat. No. 4,554,994, Weiner, is a bubble level viewed from the side to indicate the proper inclination of the ladder relative to the horizontal. Similarly, the indicators shown in U.S. Pat. No. 2,845,719, Thomiszer, and U.S. Pat. No. 3,118,234, Wilson, show devices for indicating the angular orientation of the ladder viewed from the side of the ladder. These devices have the disadvantage of requiring the user to perform a “two-step process” of adjustment to the ladder to position it properly according to conventional safety regulations. The user must adjust the position of the ladder relative to the vertical then move to the side and check the angle of inclination. If it is not correct, the user must repeat the steps until the ladder is positioned correctly. This method is difficult and time consuming, especially with long ladders. The bubble type indicator has the added disadvantage of only approximately indicating the optimal angle of inclination.

The primary objective of this invention is to overcome the disadvantage of side viewing by providing a clear indication of the optimal angle of inclination from both the front and side of the ladder; furthermore, it can be adjusted to varying heights depending on the user. It allows the ladder to be positioned in one motion by moving the base of the ladder either inwards toward the vertical or outward away from the vertical until the indicator points are in alignment with the preset index marks. This indicates the optimal angle of inclination (75½ degrees) from the horizontal.

The secondary objective of this invention is to provide a self clamping mechanism that has an automatic built-in spring safety release and does not affect the strength of the ladder. It is a portable device which may be applied to any type of new or existing ladder made of wood, aluminum, fiberglass, or similar materials. It is easily attached and removed and adjusts by pressure to fit ladders of varying rail widths without the need for modification or adjustment to the ladder. It does not affect the integrity or strength of the ladder.

### SUMMARY OF THE INVENTION

The invention, by design, is self fastening and is made of metal and/or plastic. It is easily applied to all types and makes of straight and extendable ladders. The invention can be fitted to new and existing ladders without any adjustments or modifications to the ladder. The present invention is an improvement over the prior art because the correct angle of inclination can be read from the front and side of the ladder (invention) while adjustments are performed to the ladder; it does not affect the strength of the ladder; and it has a built-in safety release mechanism. For complete description and understanding of the objectives and advantages of the invention, reference should be made to the drawings and detailed description of the preferred embodiment.

### REFERENCE TO DRAWINGS

The objects and advantages are achieved by are achieved by the device shown in our drawings.

FIG. 1 illustrates 2D left side view of the invention

FIG. 2 illustrates 2D top view of the invention.

FIG. 3 illustrates 2D front view of the invention.

FIG. 4 illustrates 2D bottom view of the invention.

FIG. 5 illustrates 2D right side view of the invention.

FIG. 6 illustrates 2D back view of the invention.

FIG. 7 illustrates the front elevation of the invention attached to a ladder.

FIG. 8 illustrates the side elevation of the invention attached to a ladder.

FIG. 9 illustrates the invention in use on a ladder against a wall

FIG. 10 illustrates 2D right side view of the invention.

FIG. 11 illustrates 2D back view of the invention.

FIG. 12 illustrates 2D right side view of the invention.

FIG. 13 illustrates 2D back view of the invention.

### SPECIFICATIONS

Referring to the drawings in detail:

The invention has a base 1 [FIG. 2] which is C-shaped. The front side wall 2 of the base attaches to the front of the ladder and contains the preset index mark 4 to indicate the correct inclination angle. The back side wall 3 of the base acts as the supporting structure for the self-clamping mechanism. The middle side wall 1 of the base acts as the support for the pendulum control arm 6 and contains the preset index mark 12 to indicate correct inclination angle (75½ degrees).

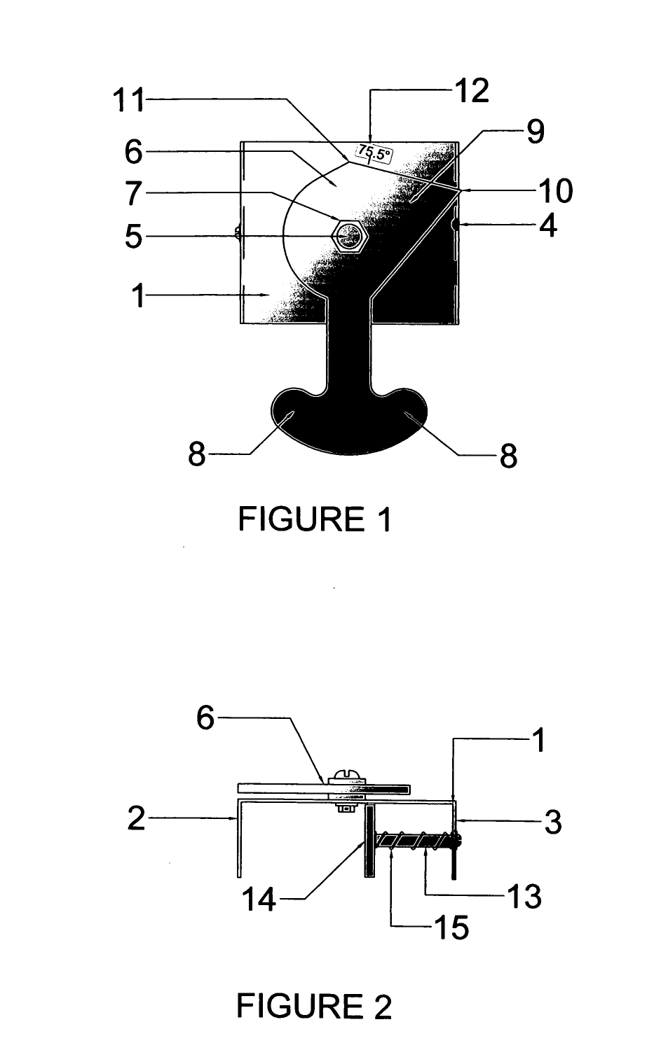

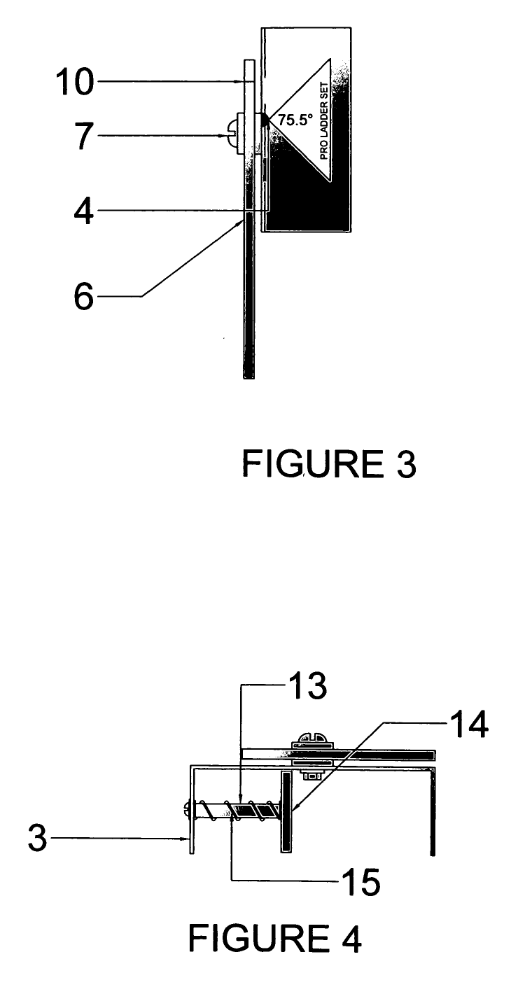

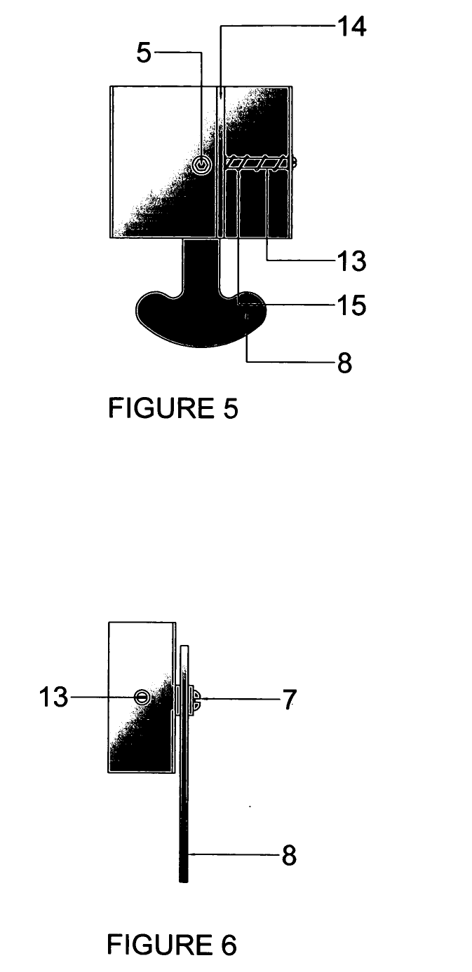

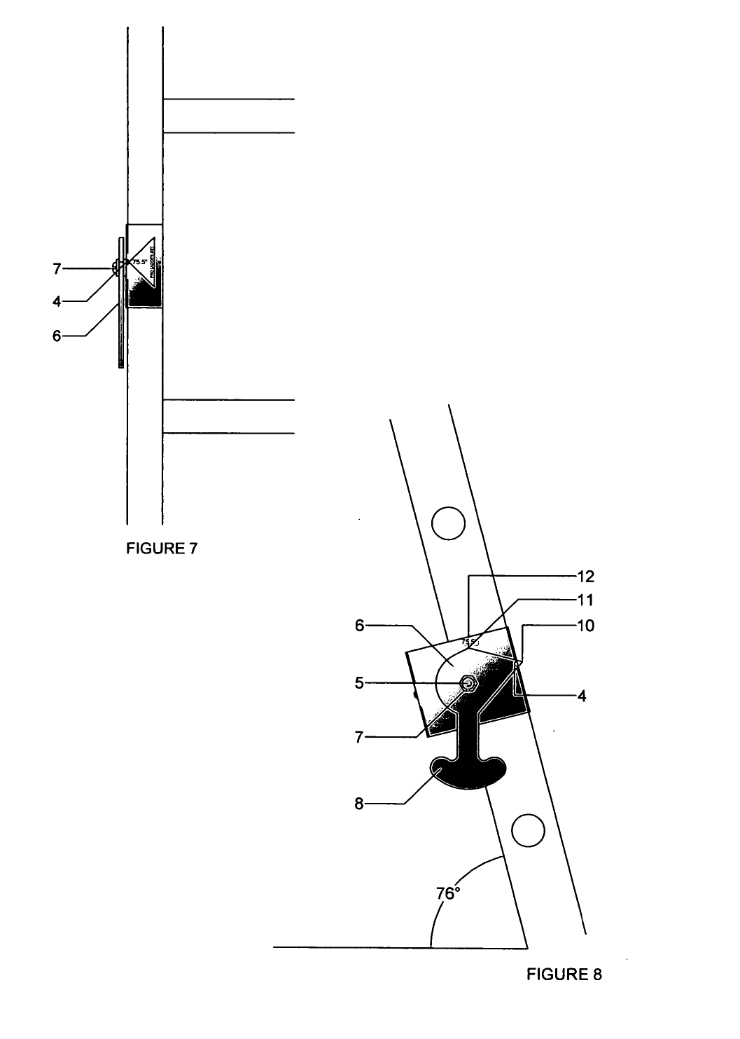

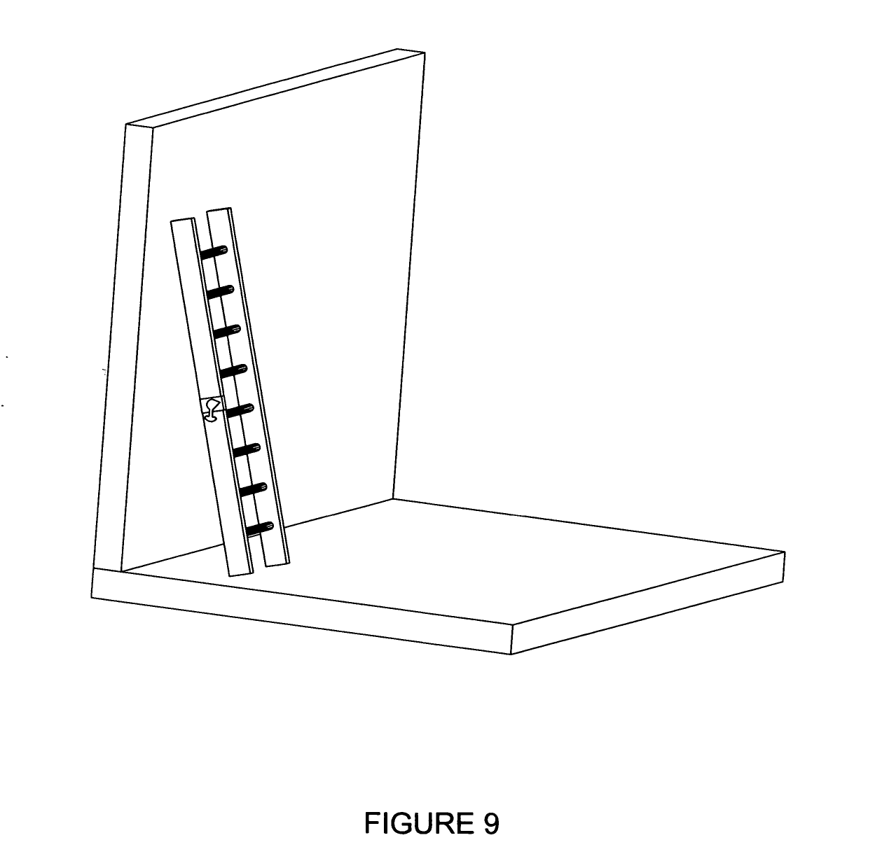

The pendulum control arm 6 [FIG. 1] rotates freely on an axle 5 that is attached to the middle side wall of the base 1 and the pendulum control arm 6. The pendulum control arm 6 is locked in place on the axle 5 with a nut 7. The pendulum control arm 6 has a counter-weighted base 8 so that the pendulum can respond to gravitational attraction. It also has a control arm 9 that is designed to come to an indicator point 10 that aligns with the preset index mark 4 on the front side wall 2 of the base to indicate the correct angle of inclination (75½ degrees) of the ladder from the front of the ladder. It also has an indicator point 11 on top that lines up with the index mark 12 on the middle sidewall of the base 1 to indicate the correct angle of inclination (75½ degrees) of the ladder from the side of the ladder.

The back side wall of the base 3 [FIG. 4] contains a connecting rod 13 that slides to accommodate the width of all ladder siderails and is connected to a clamping plate 14 through a spring 15. The spring 15 is sufficiently strong to provide a self clamping mechanism to the ladder but not strong enough to prevent it from easily disconnecting from the ladder should it be accidentally bumped by the user's foot etc. which could cause an accident.

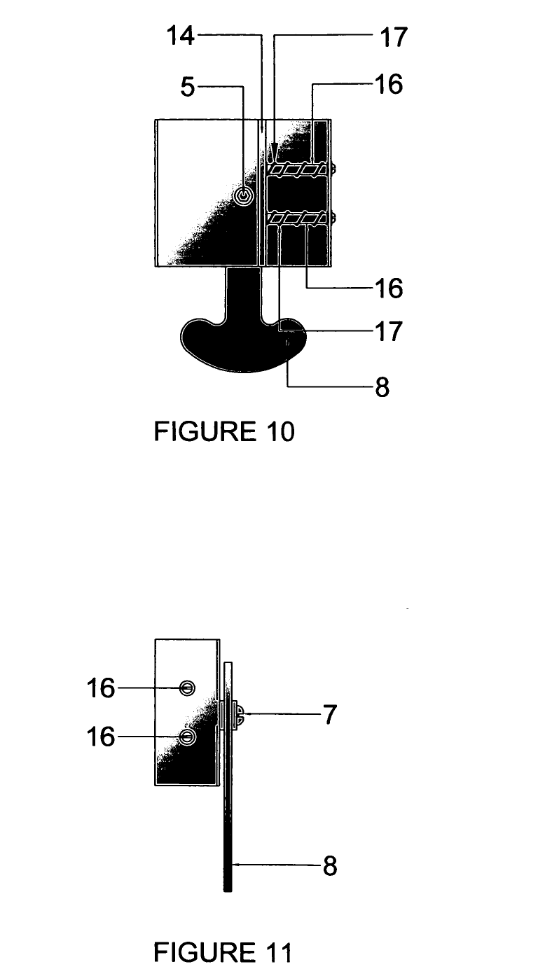

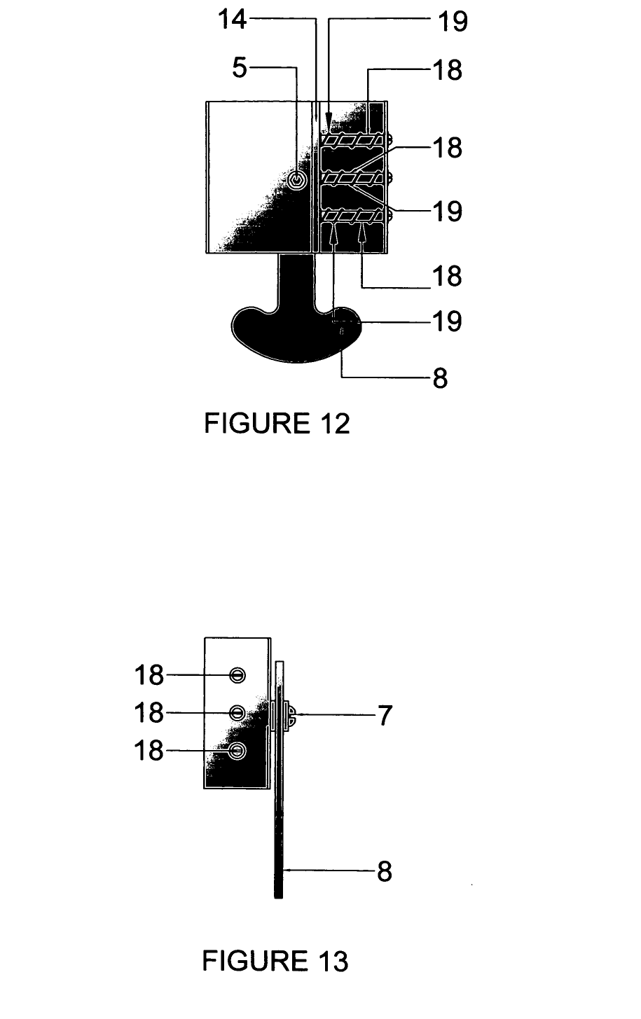

The foregoing is intended to be illustrative of the general form of the invention. Many changes may be made in the selection and arrangement of the various parts. For instance, using two springs where the back side wall of the base 3 [FIG. 10] contains two connecting rods 16 that slide to accommodate the width of all ladder siderails and are connected to a clamping plate 14 through springs 17. The springs 17 are sufficiently strong to provide a self clamping mechanism to the ladder but not strong enough to prevent it from easily disconnecting from the ladder should it be accidentally bumped by the user's foot etc. which could cause an accident. Also, using three springs instead of one where the back side wall of the base 3 [FIG. 12] contains three connecting rods 18 that slide to accommodate the width of all ladder siderails and is connected to a clamping plate 14 through springs 19. The springs 19 are sufficiently strong to provide a self clamping mechanism to the ladder but not strong enough to prevent it from easily disconnecting from the ladder should it be accidentally bumped by the user's foot etc. Furthermore, painting different patterns on the base and pendulum control arm to highlight the correct position are within the scope of the claims without departing from the spirit of the invention.

1. A safe inclination indicator for ladders comprising
A base that is C shaped and contains preset index marks on both the front side wall and middle side wall that line up with indicator points on a pendulum control arm to indicate the correct angle of inclination of a ladder that can be read from both the front and side of the ladder.
A pendulum control arm that is designed to contain preset indicator points on the top and side that line up with index marks on the front side wall and middle side wall of the base to indicate the correct angle of inclination of a ladder that can be read from both the front and side of the ladder.
An axle connecting the pendulum to the base.

2. A safe inclination indicator for ladders of claim 1 wherein,
A self clamping mechanism that is connected to the back side wall of the base by one or more sliding connecting rods through one or more springs.
